(19) United States
(12) Patent Application Publication
(10) Pub. No.: US 2008/0043727 A1
(43) Pub. Date: Feb. 21, 2008

(54) Method and apparatus for visual message indication in a VoIP system

(75) Inventor: Don Smitheimer, Morganville, NJ (US)

Correspondence Address: VONAGE, 23 MAIN STREET, HOLMDEL, NJ, 07733, US

(73) Assignee: Vonage Network Inc.

(21) Appl. No.: 11/824,715

(22) Filed: Jun. 29, 2007

Related U.S. Application Data
(60) Provisional application No. 60/817,397, filed on Jun. 30, 2006.

(51) Int. Cl. H04L 12/66

(52) U.S. Cl. 370/352

(57) ABSTRACT

Method and apparatus to provide a numerical verification of new and existing voice messages as it relates to subscribers of VOIP services. The apparatus is placed on the subscriber's telephone line; the subscriber's VOIP voice message servers call and update the device with the subscriber's current voice message status including the number of existing messages and new message(s). The apparatus is equipped to display the number of existing and new messages.

### CROSS-REFERENCE TO RELATED APPLICATIONS

This application claims priority to U.S. provisional application Ser. No. 60/817,397, filed Jun. 30, 2006, which is incorporated by reference herein in its entirety.

### BACKGROUND

Current Voice over IP (VOIP) providers offer voice message service to their customers typically by storing voice message audio on devices (e.g., high capacity servers) located within provider's infrastructure or accessible through the provider's infrastructure. Customers access voice messages via telephone or Internet web interface. Unfortunately, VoIP customers are not aware of the number of existing or new voice messages unless they call their own phone number to access the voice message server(s) or log onto a website and check online. Upon taking their phone “off-hook”, they normally will be notified by a “stutter ring” if there is at least one message, either new or old, on the voice message servers. As such, the lack of visual information regarding voice messages at or near the customer's telephone can be an annoyance or even detriment to continuing with the service. Similarly, the need to access a website to check for voice messages requires extra steps with different equipment that is inconvenient and possibly unproductive.

Accordingly, there is a need in the art for a method and apparatus for visually and more comprehensively conveying voicemail status to VoIP customers.

### SUMMARY

The disadvantages associated with the prior art are overcome by an apparatus and method for visual indication of voice messages. The apparatus includes means for detecting signaling indicative of an incoming telephone call, means for determining the identity of the caller of the incoming telephone call means for processing information indicative of voice message status at a voice message server and a display means for providing visual indication of voice message status based on the processed information. The apparatus is adapted for connecting to POTS-type equipment and packet-based network equipment to facilitate communication of voice message information between same. The method for conveying visual indication of voice messages includes detecting signaling indicative of an incoming telephone call, determining the identity of the caller of the incoming telephone call, processing information indicative of voice message status at a voice message server if the identity of the caller is a voice message server and displaying visual information indicative of voice message status based on the processed information.

### BRIEF DESCRIPTION OF THE FIGURES

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a system employing a method and apparatus for visual notification of a voice message in accordance with the subject invention;

FIG. 2 depicts a process flow of operations of a Voice Message Indicator on the subject invention;

FIG. 3 depicts a process by which voice messages are recorded in the subject invention;

FIG. 4 depict a process for updating a Voice Message Indicator of the subject invention; and

FIG. 5 depicts the functional modules of the Voice Message Indicator of the subject invention;

To facilitate understanding, identical reference numerals have been used, where possible, to designate identical elements that are common to the figures.

### DETAILED DESCRIPTION

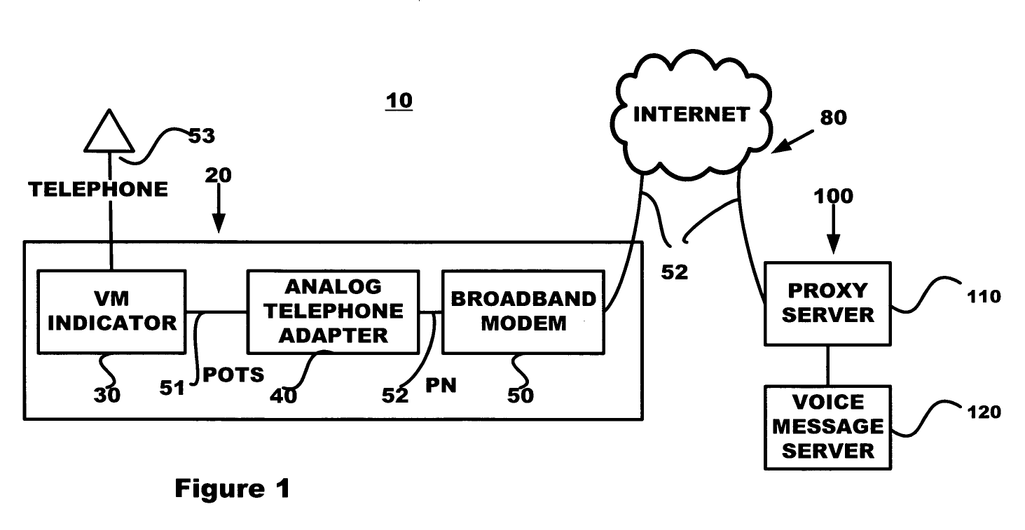

FIG. 1 depicts a system 10 employing a method and apparatus for visual notification of a voice message in accordance with the subject invention. Specifically, Customer Premises Equipment (CPE) 20 provides an example of a VoIP subscriber's interconnecting devices including a Voice Message Indicator 30, an analog telephone adapter (ATA) 40 and a broadband Modem 50 normally located at the customers location. The Voice Message Indicator 30 may be connected to the subscriber's existing Plain Old Telephone Service (POTS) which includes a POTS telephone 53 and POTS line 51 (e.g. a twisted pair copper line or the like), on which also resides the ATA 40, used to enable VoIP. The Modem 50, which provides required bandwidth for VOIP is connected to the ATA 40. The Modem 50 is connected to a packet-based network 80 (e.g. the Internet) via connection 52. As such, the subscriber's CPE 20 and a VoIP provider's infrastructure 100 communicate over a packet-based connection 52 via the Internet 80 or other packet based network. While there are many aspects and components of a VoIP provider's service, only the parts of a VOIP service provider's infrastructure 100 that are pertinent to this disclosure as presented. Infrastructure 100 includes a Proxy Server 110, used to provide signaling and a voice message server 120, on which audio messages are stored and indexed. While not described, other services associated with the VoIP service or Internet are envisioned to be interoperative with the Voice Message Indicator 30 as well.

One possible signaling protocol that may be used in the subject invention is the Session Initiation Protocol (SIP) which is a signaling protocol for initiating, managing and terminating media (e.g., voice, data and video) sessions across packet based networks that typically use the Internet Protocol (IP) of which VoIP is an example. The details and functionality of SIP can be found in the Internet Engineering Task Force (IETF) Request for Comments (RFC) Paper No. 3261 entitled, “SIP: Session Initiation Protocol” herein incorporated in its entirety by reference. SIP establishes and negotiates a session, including the modification or termination of a session. It uses a location-independent address system feature in which called parties can be reached based on a party's name. SIP supports name mapping and redirection allowing users to initiate and receive communication from any location. While SIP is a preferred protocol for the subject invention, other protocols are also applicable as known to those skilled in the art including but not limited to H.323 and MGCP. H.323 is an umbrella recommendation from the ITU Telecommunication Standardization Sector (ITU-T) that defines the protocols to provide audio-visual communication sessions on any packet network. Media Gateway Control Protocol (MGCP) is a protocol used within a distributed Voice over IP system and is defined in IETF RFC 3435.

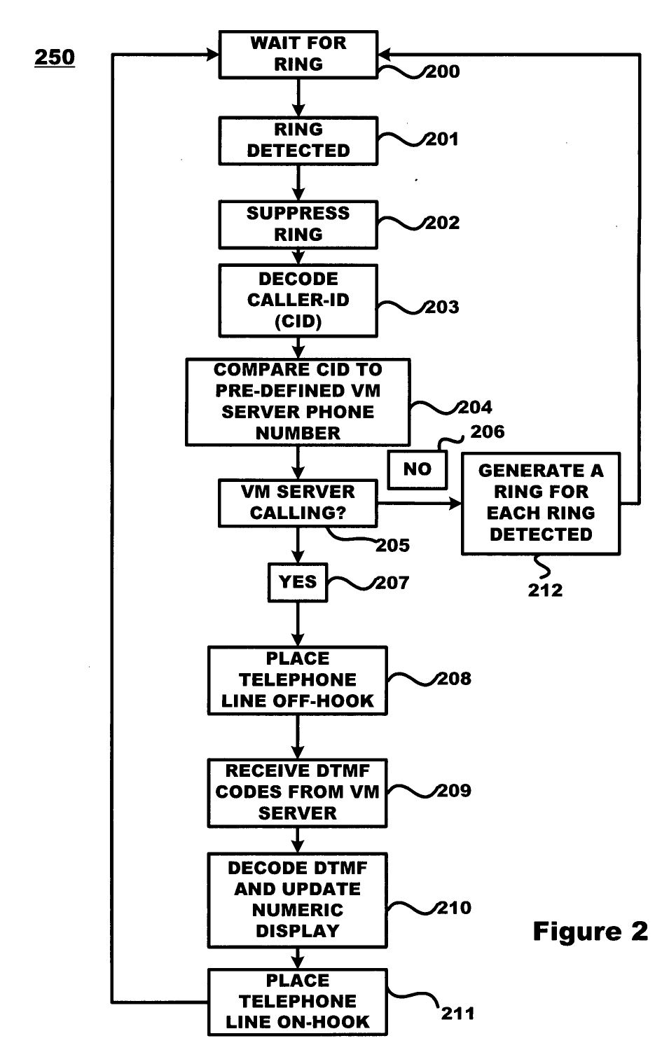

FIG. 2 is an embodiment of a method of operation for a Voice Message Indicator. Specifically, FIG. 2 depicts a process flow 250 of the Voice Message Indicator 30. When a new voice message is recorded on the voice message (VM) Server 120, it sends a SIP signal to the Proxy Server 110 to initiate a phone call to the subscriber. The details of the SIP message are known to those skilled in the art, but for exemplary purposes here, they will include the caller phone number (the VM Server's pre-configured phone number) and the recipient (i.e., subscriber's) phone number. The Proxy Server 110 then initiates the necessary SIP messages to place a phone call to the subscriber's phone.

The Voice Message Indicator 30 resides on a telephone line 51 and waits for a ring at step 200. As those skilled in the art are aware, a telephone ring typically consists of a 90V RMS AC, 20 HZ line condition. A telephone line typically has a quiescent state of −48 VDC. When a ring condition is detected at step 201 (e.g. 75 V RMS), the Voice Message Indicator 30 reacts by suppressing further rings at step 202. In one embodiment, suppression occurs by damping the voltage. Signaling between the first and second rings contains caller-ID (CID) information 203, which is decoded at step 203. At step 204, the decoded information is compared to a pre-configured VM Server 120 phone number.

At step 205, the decoded information is evaluated for its origin. If the decoded CID does not match the VM Server phone number, the Voice Message Indicator 30 determines the call was not made by the subscriber's VoIP Service Provider's VM Server 120 at step 206 and allows the call to go through by generating a ring tone for each ring it detects at step 212. If the decoded CID does match the VM Service phone number, the Voice Message Indicator 30 determines the call was made by the subscriber's VOIP Service Provider's VM Server 120 at step 207 and places the telephone line into an off-hook Condition at step 208. The off-hook condition is translated through the ATA 40 into a SIP message to the Proxy Server 110. The Proxy Server 110 sends a SIP message to the VM server 120, which returns in kind with the number of existing and new messages for the subscriber. The above SIP traffic includes the subscriber's phone number, by which the VM Server 120 can look-up the status of voice messages for the subscriber.

In one embodiment, the proxy server 110 responds to the Voice Message Indicator's 30 off hook condition described above with pre-recorded DTMF audio. The proxy server 110 determines the number of existing messages and, based on many possible schemes, sends the DTMF codes preceded by a command code. For example, the DTMF code for ‘*’ may command the Voice Message Indicator 30 to interpret the following three DTMF codes as digits for the number of existing messages. Additionally, the DTMF code for ‘#’ may command the Voice Message Indicator 30 to interpret the following three digits as the number of new messages. The ATA 40 converts SIP encoded DTMF codes into an audio signal on the POTS line 51. The Voice Message Indicator 30 decodes the DTMF code using a microprocessor programmed to decode the DTMF and interpret the commands. The microprocessor then updates the appropriate display such as with the new received data. The Voice Message Indicator 30 then places the telephone line 51 on-hook at step 211 and waits for the next occurrence (ring) at step 200.

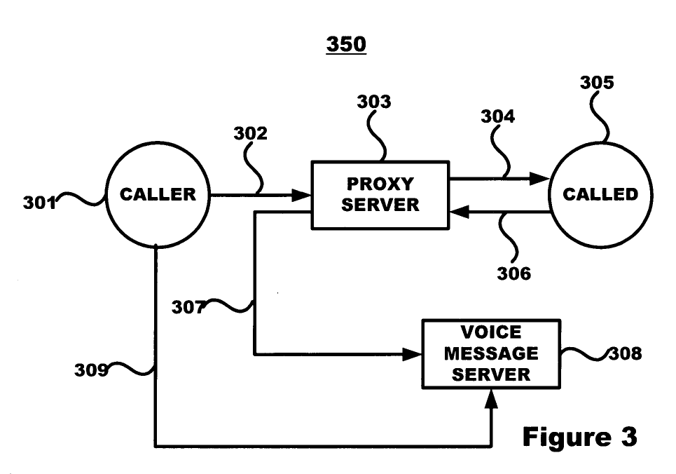

FIG. 3 is a representation of a process 350 by which voice messages are recorded in a VoIP phone system. A caller 301 places a call at step 302 to a phone number. As an example, use the U.S. standard NPANXX format, (e.g. AAA-XXX-4444). The call is routed to the caller's Proxy 303, which sends the call to the called 305 phone at step 304. The called phone rings when the call is received. If no one answers the call (i.e., if the phone is not placed off-hook), a not-answered response condition occurs at step 306. This condition is recognized by the Proxy 303 which informs the voice message server 308 to record a message at step 307. The caller 301 is then connected via the proxy server 303 or other facilitator to the voice message server 308 at step 309. As such, an audio file is created for phone number AAA-XXX-4444.

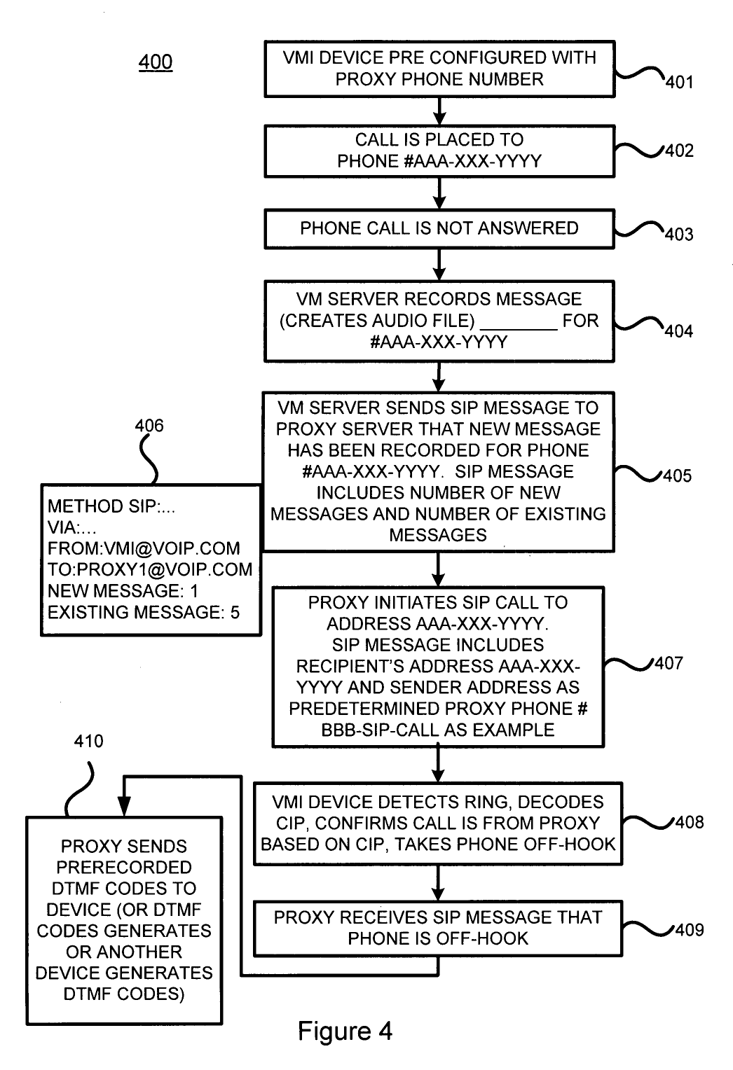

FIG. 4 describes a process 400 by which the VOIP service provider 100 may, in one exemplary method; update the Voice Message Indicator 30 with the number of new and existing (or current) messages. The Voice Message Server 120 or Proxy Server 110, or another notification-type server with similar function not discussed in the embodiment, has been given a predefined phone number. In the example of FIG. 4, this predefined phone number is BBB-SIP-CALL (when BBB may be any three digit number usually designated as an area code per U.S. standard NPANXX format). Further, the example uses the phone number AAA-XXX-YYY as the called party's phone number. The Voice Message Indicator 30 maybe manufactured with, or is in some manner programmed with, the predefined voice Message Service 120 or Proxy Server 110 phone number at step 401; this phone number is compared to the caller ID in step 204 of process 250 described above.

At step 402, a call is placed to AAA-XXX-YYYY using standard telecommunication technologies known to those skilled in the art. If the call is not answered (step 403), the caller is directed to optionally record a message for the called party at step 404, which for the purposes of this example and description the caller does. The Voice Message Server 120 is able to interrogate its voice message database to determine the number of new (not listened to) messages, and the number of existing (not deleted) messages remaining on the VM Server 120. The VM server communicates via the SIP messaging protocol or other signaling protocol to the Proxy Server 110 that a new message has been recorded and provides the proxy server the number of new messages and existing messages at step 405. An exemplary SIP header 406 is depicted; however, other types of messages (including amount of content beyond the number of messages are possible.

The proxy server 110 (or in another embodiment, another notification-type server) initiates a SIP message invitation to the called party phone number at step 407. This SIP message header 406 has as its recipient or TO: field, the called party's phone number AAA-XXX-YYYY, and in its caller or FROM: field the predefined VM server's proxy server phone number BBB-SIP-CALL. The Voice Message Indicator 30 processes the SIP phone call per the process 250 described in FIG. 2 at step 408 and takes the phone line off-hook. At step 409, the proxy 110 receives a SIP message that the phone is off-hook.

The Voice Message Indicator 30 further includes a visual display (explained in greater detail below) that is updated via micro-controlled circuitry. The micro-controller is programmed to respond to a series or sequence of DTMF codes. In one embodiment, a sequences may be that the DTMF code for the asterisk button ‘*’ defines the following three DTMF digit codes as the number of existing messages, and, further, the DTMF for ‘#’button defines the following three DTMF digit codes as the number of new messages. As noted previously since the display is capable of producing numbers and other symbols, short codes or text messages from the VoIP network can also be transmitted and displayed in the same manner. For example, if an urgent message has been received and appropriately marked, the display can indicate “URG” which would notify the customer to access there messages.

The Proxy Server 110, in one embodiment, may send the required DTMF codes to the device via the SIP messaging protocol using predefined DTMF codes pre-sampled and converted to a specific code. In another possible embodiment, the proxy sever 110, or another notification-type server, may generate the necessary DTMF codes using various, existing generation techniques known to those skilled in the art at step 410.

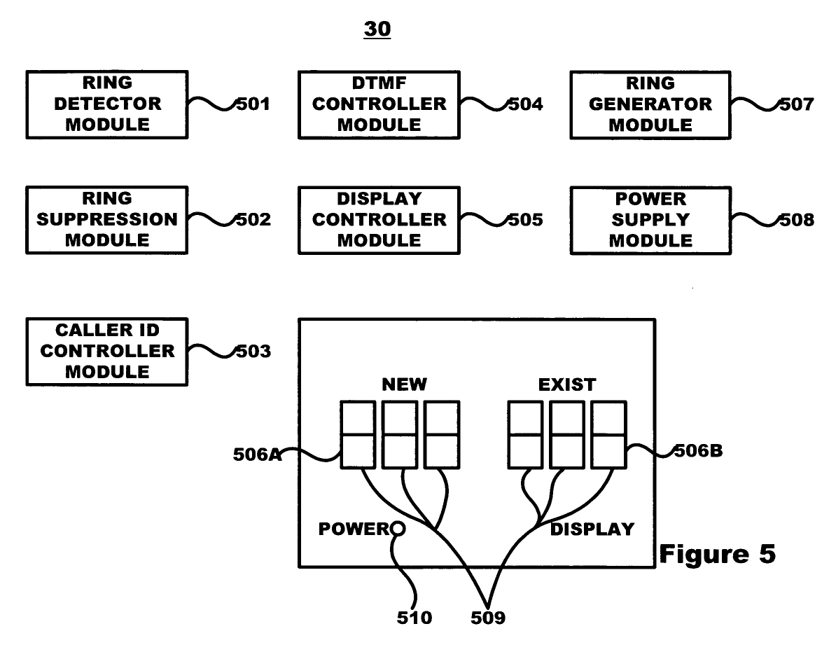

FIG. 5 represents the function modules that comprise the Voice Message Indicator 30. The purpose of the Ring Detector Module 501 is to make customer's aware of an incoming call. On a typical POTS line in the U.S., voltage across the pair of wires, in an on-hook, quiescent state, is −48VDC. The voltage in a ringing state is 90 V RMS AC at 20 Hz. When the ring Detector Module 501 detects a signal near 90 V RMS at 20 Hz, it passes the signal to the next stage, the Ring Suppression Module 502.

Ring Suppression Module 502's purpose is to prevent the POTS line phones from ringing. Since the method by which this invention is updated is with Voice Message Data, it requires the VM Indicator 30 to be called from a known source. If the phone were to ring and be answered, the device could not be contacted since the POTS line is off-hook. Suppressing the ring precludes someone from causing the line to go off-hook. One embodiment of this module may be the use of discrete electronic components, such as diodes and opto-isolators, to prevent the voltage and signal from reaching 90 V RMS at 20 Hz.

The caller ID controller module's 503 has a two-fold function: a) to detect and decode the caller ID data contained in the phone call; and b) to compare the detected number to the predefined Voice Message Server 120 or proxy number as discussed in FIG. 4. Caller ID data is normally sent in the 2 second gap between the first and second rings. The USA and Europe use two different methods to send CID information: The U.S. uses the Bellcore System which sends the data in packets sent at 1200 bps (based) using FSK-Modem. In some European countries, the CID is sent using standard DTMF signaling.

One embodiment of the first function of the CID module 503 is to use commercially available integrated circuits (IC's). Another embodiment is to incorporate or utilize a micro-controller to detect and decode CID. The micro-controller would be designed with other discrete electronic components to properly detect/decode CID. The second function of CID module 503 is to compare the detected CID to predefined numbers, e.g. the number of the VM server 110 can be achieved, in one embodiment, with a micro-controller.

As described in step 205, if the comparison of CID to predefined number has the result of being a match, the Voice Message Indicator 30 takes the POTS line 51 off-hook. This action can be incorporated in CID module 503. The Proxy Server 110 detects the off-hook condition via a SIP initiation message, as described in FIG. 4 at step 409. The Proxy Server 110, in the embodiment described herein, sends the DTMF codes to the Voice Message Indicator 30 as shown in 410.

The purpose of the DTMF controller module 504 is to detect, decode, and interpret the DTMF formatted code commands sent from the Proxy Server 110 or other notification-type device. As described in FIG. 4, many command-oriented schemes are possible wherein the codes define the number of new and existing messages. DTMF controller module 504 may be implemented by commercially available integrated circuits to decode DTMF tones, or, in an alternate embodiment, a micro-controller may be programmed to perform the decode function. Similarly, IC's ASICs or microcontroller's may be implemented to interpret the command stream based on a predefined command scheme. Programmed microcontroller or processors would also preferably be reprogrammed to allow for expansion of the Voice Message Indicators capabilities.

The Display Controller module 505 drives a display 506. In this example, the visual display 506 of the number of existing 506a and new 506b messages is provided by the use of discrete electronic components, 7 segment LED's or LCD's 509. In the display 506, the 7 segment LED's 509 represent one digit, so that each message number has three digits to represent the number of messages, both new and existing. Additionally, a small LED 510 is used to provide a visual indication that device power is either present or absent. Display Controller module 505 is functionally separate from DTMF Controller module 504 but may be incorporated into same such that the same electronic circuitry that decodes and interprets DTMF codes, may be used, with a small number of additional discrete electronic components to drive the display 506. Additionally, in one embodiment, Display Controller module 505 may have the added requirement to put the POTS line 51 on-hook after the display 506 has been updated, per step 211.

The Ring Generator Module 507 contains the necessary electronic circuitry, known to those skilled in the art, to generate the necessary voltage and signal to cause a typical phone to ring. The ring generation function is necessary given that Ring Suppression module 502 had suppressed the ring. If the result of the test of step 205 is false, a ring signal must be generated so that phones ring and notify individuals of an incoming call.

The Power Supply Module 508 provides sufficient power to the Voice Message Indicator 30 for it to perform all required functions. One embodiment is to use wall power via a plug; another embodiment is to make judicious use of batteries and electronic components known to those skilled in the art.

While foregoing is directed to embodiments of the present invention, other and further embodiments of the invention may be devised without departing from the basic scope thereof, and the scope thereof.

What is claimed is:

1. An apparatus for visual indication of voice messages in a Voice over Internet Protocol (VoIP) system comprising:
means for detecting signaling indicative of an incoming telephone call;
means for determining the identity of the caller of the incoming telephone call;
means for processing packet-based network information indicative of voice message status at a voice message server; and
a display means for providing visual indication of voice message status based on the processed information.

2. A method for conveying visual indication of voice messages Voice over Internet Protocol (VoIP) system comprising:
detecting signaling indicative of an incoming telephone call;
determining the identity of the caller of the incoming telephone call;
processing packet-based network information indicative of voice message status at a voice message server if the identity of the caller is a voice message server; and
displaying visual information indicative of voice message status based on the processed information.
